(19) United States
(12) Patent Application Publication
(10) Pub. No.: US 2008/0127620 A1
(43) Pub. Date: Jun. 5, 2008

(54) CLEARING DEVICE AND METHOD

(76) Inventor: Michael Marcinczyk, Virginia Beach, VA (US)

Correspondence Address: COZEN O'CONNOR, P.C., 1900 MARKET STREET, PHILADELPHIA, PA, 19103-3508, US

(21) Appl. No.: 11/566,121

(22) Filed: Dec. 1, 2006

(51) Int. Cl. A01D 34/00

(52) U.S. Cl. 56/12.7

(57) ABSTRACT

A carriage for supporting a clearing device of the type having an elongated support tube having a proximal end and a distal end, a clearing head mounted at the distal end of the elongated support tube, a motor mounted at the proximal end of the elongated support tube, and drive means connecting the clearing head to the motor is disclosed. The carriage comprises a first mounting bracket; a second mounting bracket; a curved, L-shaped, or angular wheel support member; a castor bracket; a single support wheel; and a guide handle; the guide handle mounted in the first mounting bracket and of sufficient length and configuration that it can be grasped by an operator for guiding the carriage during use; the first mounting bracket and the second mounting bracket each adapted to be mounted on the elongated support tube of the clearing device at different positions; the castor bracket including a castor pin extending vertically from a transverse plate, a pair of castor wheel struts extending from the transverse plate, a wheel axle extending between the pair of castor wheel struts, and the single support wheel rotatably mounted on the wheel axle; the curved wheel support member having a plurality of holes for receiving the castor pin; the castor pin being removable and relocatable at any of the plurality of holes so the wheel may be located at a selected position along the curved wheel support member. A method of supporting a clearing device and a system including the supported clearing device are also disclosed.

### BACKGROUND OF THE INVENTION

This invention relates to support systems for clearing devices.

Hand held clearing devices for lawn, garden, and farm use such as tillers, trimmers, blowers, edgers, bush cutters, string trimmers and string edgers, commonly known as “weed whackers,” are very well known and are widely used by home owners, lawn care services, and agricultural workers for various tasks. These clearing devices have an elongated support tube having a proximal end and a distal end, a clearing head mounted at the distal end of the elongated support tube, a motor mounted at the proximal end of the elongated support tube, and drive means connecting the clearing head to the motor. Although these clearing devices are most commonly hand held and thus used without any special supporting systems, many support systems comprising one or more wheels have been proposed over the years.

Examples of such support systems are shown in Foster, U.S. Pat. Nos. 5,613,354 and 5,279,102, Pulley, U.S. Pat. No. 5,317,807, and patents cited therein. No such prior support system has achieved any significant commercial success.

Therefore there is a need in this art for an improved support system for clearing devices.

### SUMMARY OF THE INVENTION

This need is addressed by the present invention which comprises in one aspect a carriage for supporting a clearing device of the type having an elongated support tube having a proximal end and a distal end, a clearing head mounted at the distal end of the elongated support tube, a motor mounted at the proximal end of the elongated support tube, and drive means connecting the clearing head to the motor; the carriage comprising a first mounting bracket; a second mounting bracket; a castor bracket; a single support wheel; and a guide handle; the guide handle mounted in the first mounting bracket and of sufficient length and configuration that it can be grasped by an operator for guiding the carriage during use; the first mounting bracket and the second mounting bracket each adapted to be mounted on the elongated support tube of the clearing device at different positions; the castor bracket including a castor pin extending vertically from a transverse plate and through a hole in the wheel support member, a pair of castor wheel struts extending from the transverse plate, a wheel axle extending between the pair of castor wheel struts, and the single support wheel rotatably mounted on the wheel axle; a curved, L-shaped, or angular wheel support member having two or more holes for receiving the castor pin; the castor pin being removable and relocatable at any of the two or more holes so the wheel may be located at a selected position along the wheel support member; the two or more holes arranged to be perpendicular or near perpendicular to the ground when the clearing head is lowered and the device is in use.

In another aspect, the invention comprises a clearing system which includes the clearing apparatus and the carriage, where the clearing apparatus is supported by the carriage.

A further aspect of the invention comprises a method of supporting the clearing device by securing it to the carriage.

Preferably the wheel axle is offset from the castor pin so that the wheel rotates in a horizontal plane around the axis of the vertical castor pin as the clearing device is guided in different directions and so that the single support wheel will tend to trail the direction of movement of the clearing device. The offset angle between the transverse plate and either of the wheel struts is preferably about 1-89 degrees, more preferably about 35-75 degrees, and most preferably about 50-60 degrees.

The first mounting bracket in some embodiments includes rotation restriction means to release or reengage the guide handle to selectively permit rotation of the guide means to adapt the carriage for either right handed users, left handed users, or storage. The rotation restriction means can be a spring button or any other mechanism. The guide handle in some embodiments allows adjustability of the length of the guide handle for different size users.

The mounting brackets in some embodiments comprise a pair of mounting members which can be clamped around the elongated support tube of the clearing device and maintained in place with screws or bolts.

The clearing system can be, for example, a tiller, trimmer, blower, edger, bush cutter, string trimmer, string edger, weed whacker, or combinations thereof.

The curved, L-shaped, or angular wheel support member for receiving the castor pin can optionally be marked to indicate corresponding hand height from the ground when the castor pin is in each selectable hole.

The first and second mounting brackets in some embodiments are adapted to be loosened to allow free rotation of the elongated support tube so that the clearing device can be selectively operated with a cutter angle parallel to the ground or at an edger angle. A collar can be provided on the elongated support tube adjacent and proximal and or distal to the first and or second mounting bracket, arranged to prevent the elongated support tube from sliding forward or backwards during the free rotation.

The clearing device can be secured to the support carriage by a variety of means, for example the first and second mounting brackets can be placed around the elongated support tube of the clearing device.

### BRIEF DESCRIPTION OF THE DRAWINGS

Reference will be made to the accompanying drawings wherein like reference numerals denote like structures and elements.

FIG. 1 is a perspective view of one embodiment of a clearing system according to the invention.

FIG. 2 is a side view of a clearing system according to the invention.

FIG. 3 is a side view of a first mounting bracket mounted on an elongated support tube of a clearing device.

FIG. 4 is a side view of a castor bracket including a castor pin extending vertically from a transverse plate, directed toward a hole for receiving the castor pin in a section of a wheel support member.

FIG. 5 is a side view of the castor support bracket with the castor pin received in the hole in the wheel support member.

FIG. 6 is a side view of the castor support bracket and wheel support member of FIG. 5, showing the side of the wheel and the angle of a wheel strut from the wheel axis to a point where the strut meets the transverse plate.

FIG. 7 is a side view of the clearing system shown in FIG. 1 resting on its side.

FIG. 8 is a side view of the first mounting bracket of FIG. 3 illustrating a tightening knob.

FIG. 9 is a side view of the mounting bracket of FIG. 8 turned slightly to the right.

FIG. 10 is a side view of the clearing apparatus of the invention.

FIG. 11 is a view similar to that of FIG. 10 except with the wheel shown turned in the opposite direction.

FIG. 12 is a perspective exploded view of a collar for the mounting members to be used on the elongated support member.

FIGS. 13 and 14 are views of an edger head shown in two different positions, for vertical cutting and horizontal cutting.

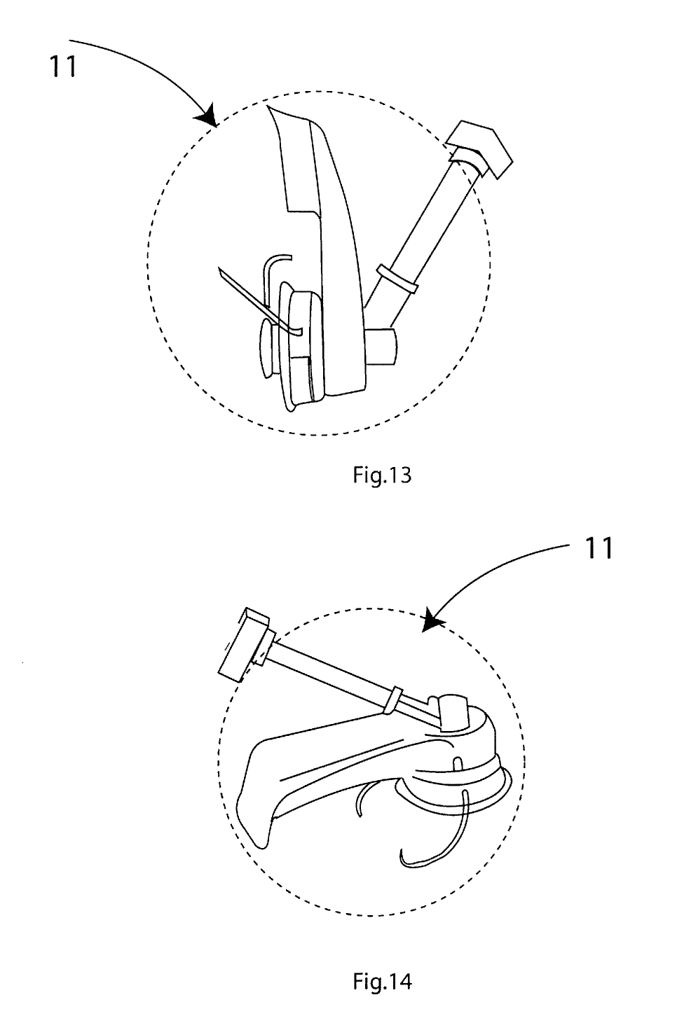

FIG. 15 illustrates three different wheel strut angles.

FIG. 16 is a right side view of a second embodiment of the clearing system of the invention.

FIG. 17 is left side view of the second embodiment of the clearing system of the invention.

### DETAILED DESCRIPTION

The invention will be further described by reference to the figures, in which like references designate like elements performing the same functions.

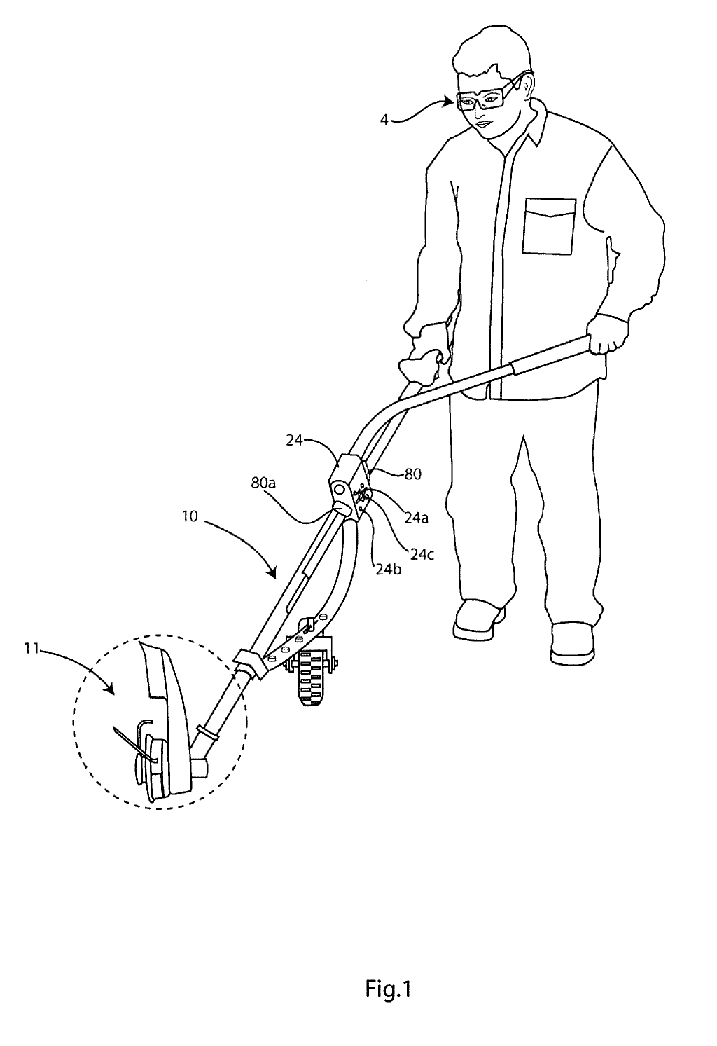

Referring first to FIG. 1, a clearing device 10 is shown being operated by a man. The clearing device has a first bracket 24 with a spring button 24a to release the guide handle so it may be rotated to accommodate left or right hand users. In this drawing, the guide handle is being held by the man's left hand. Bolts 24b secure the first bracket 24 to the main shaft of the clearing device. A clearing head 11 is shown in vertical position for use as an edger.

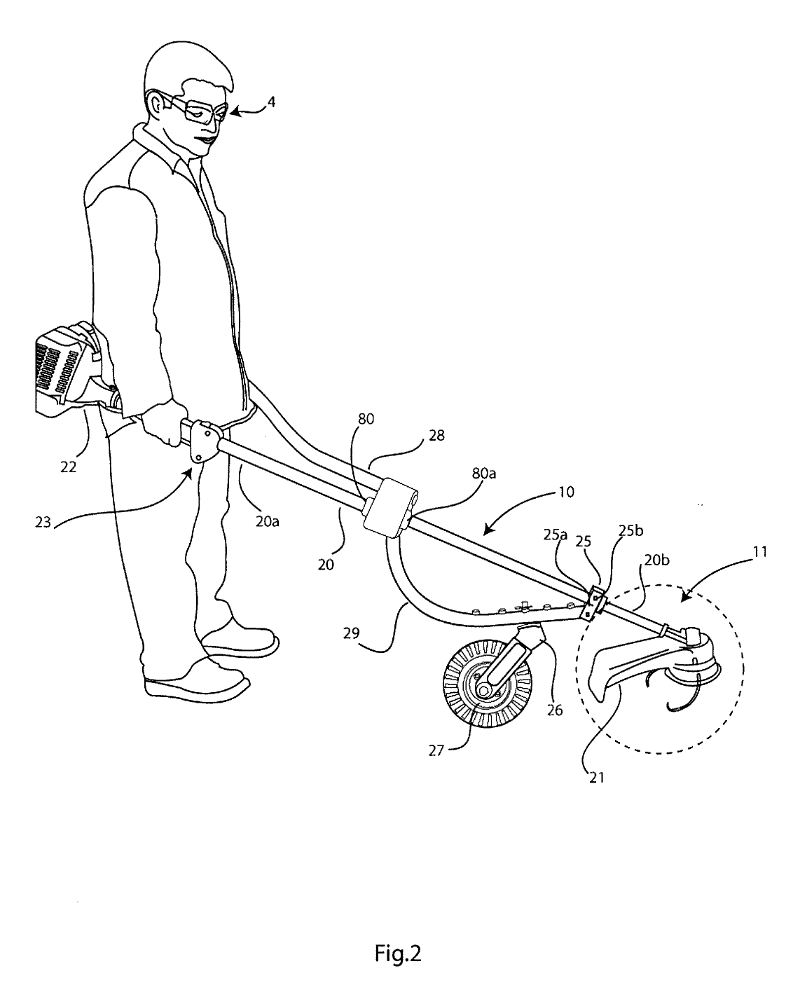

FIG. 2 is a right side view of the same embodiment as illustrated in FIG. 1, with motor 22 secured to the elongated straight support tube 20 by means of bracket 23, the elongated straight support tube having a proximal portion 20 and a distal end 20b closer to string clearing head 21. Guide handle 28 is mounted in first mounting bracket 24. Curved wheel support member 29 is secured at one end in first mounting bracket 24 and at the other end in second mounting bracket 25, having a right side 25a and a left side, secured by bolts 25b. Wheel 27 is mounted on a wheel strut, a mounting 26 for a transverse plate, and a castor pin.

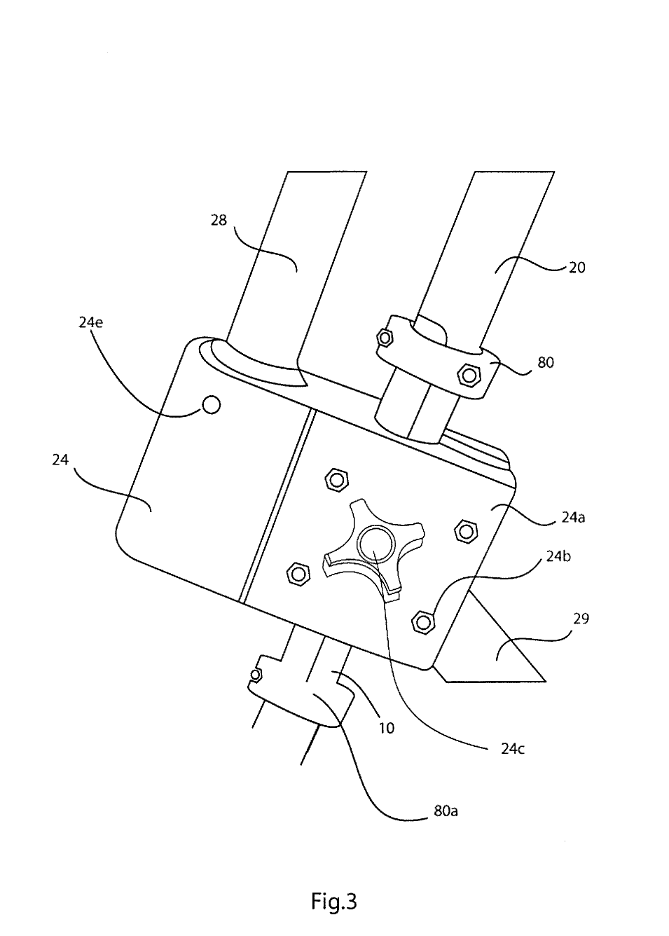

FIG. 3 illustrates a first mounting bracket 24 which secures guide handle 28, elongated support tube 20, and clearing device 10. A spring button 24e] is used to release the guide handle for rotation to left hand or right hand positions. Bolts 24b secure the first mounting member to the curved wheel support member as well as the elongated support tube 20 and guide handle 28.

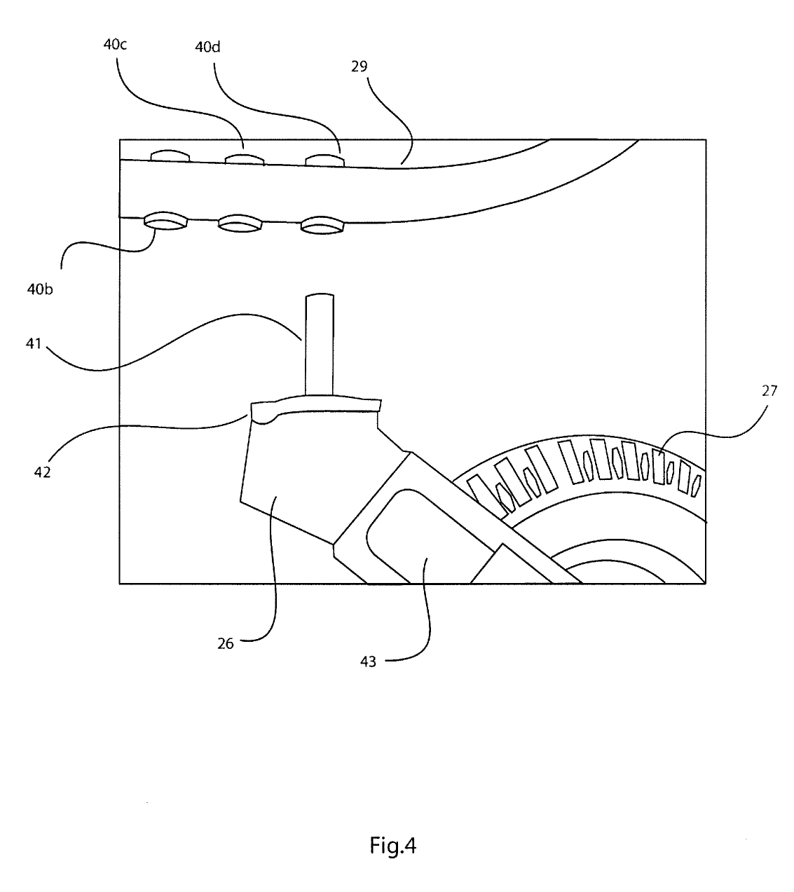

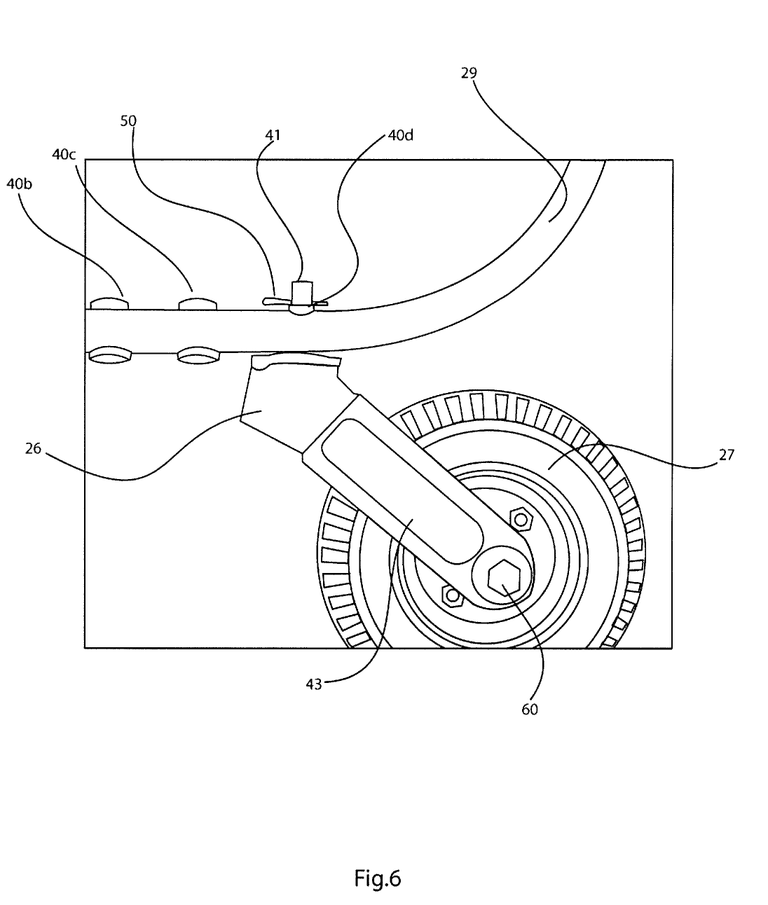

FIG. 4 illustrates in detail how the castor pin 41 may be arranged on transverse plate 42, supported by transverse plate mounting 26 and joined to strut 43 which is arranged at a certain angle to offset the wheel axle 60 (FIG. 6) so that the wheel 27 trails the direction of movement in which the overall clearing device 10 is moved by the operator.

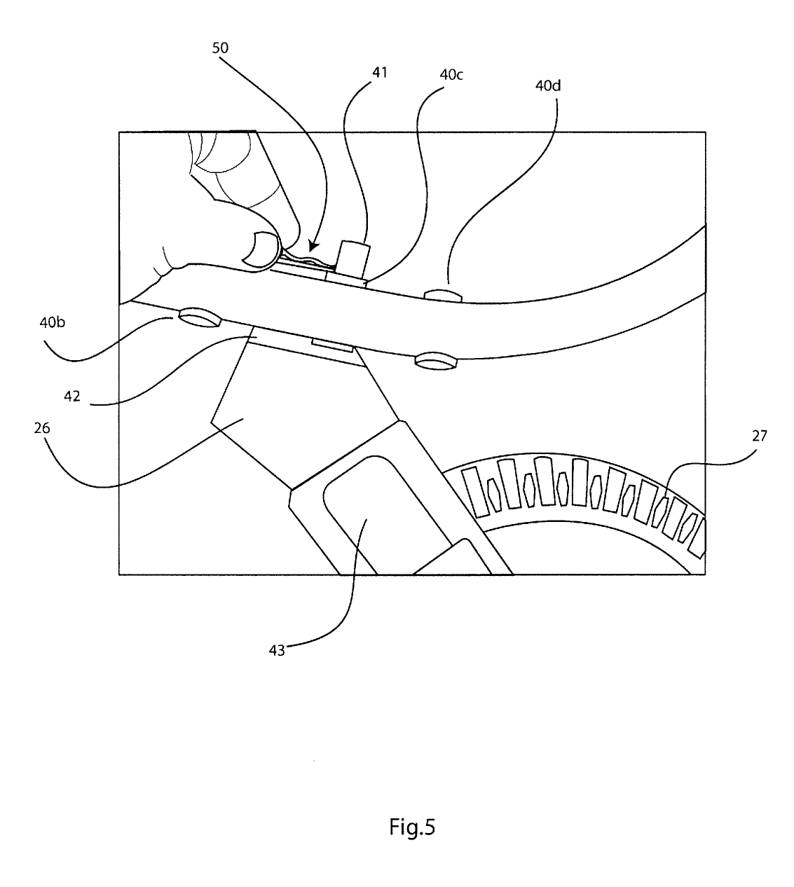

FIG. 5 illustrates in detail how the caster pin 41 is received in a selected hole, 40c in the illustrated case, and a bridge pin 50 is used to lock the caster pin from being withdrawn but allows the caster pin 41 to rotate as needed.

FIG. 6 is a view similar to FIG. 5 with the caster pin 41 in locked position. In this view, wheel axle 60 is shown.

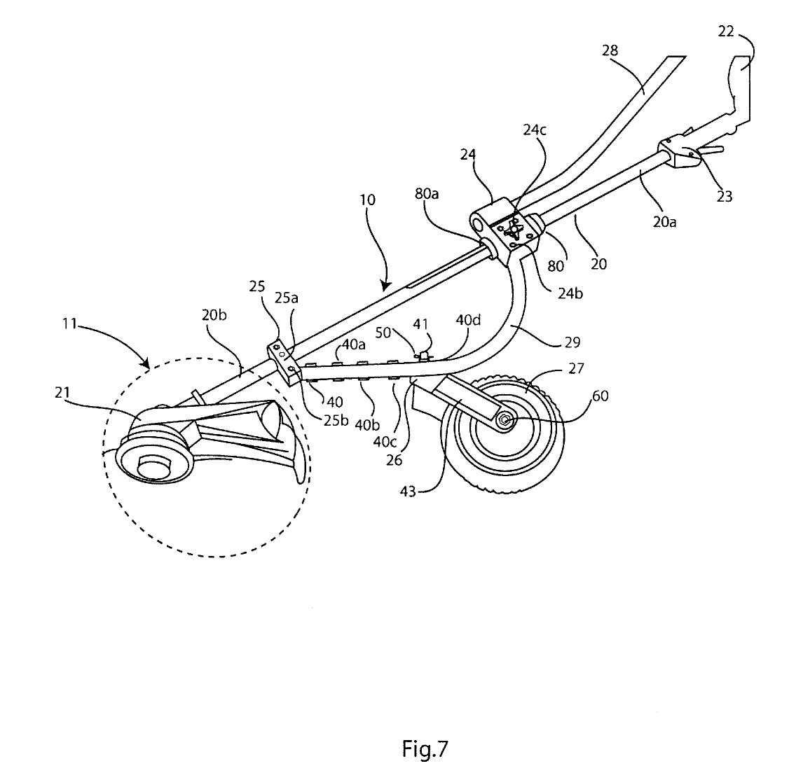

FIG. 7 is a side view of the clearing device 10, illustrating the handle 22 at the proximal end 20a of the elongated support tube.

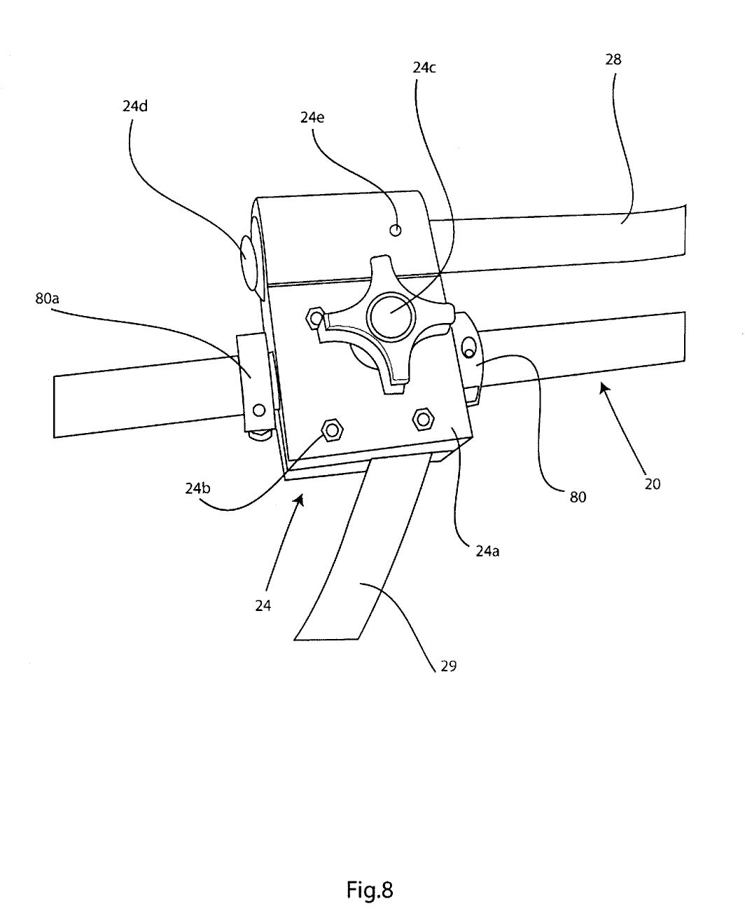

FIG. 8 shows detail of a first mounting bracket 24 and how it may be arranged to join curved wheel support member 29, elongated support tube 20, and guide handle 28, and may be secured with bolts 24b and tightening handle 24c, and clamps 80 and 80a to prevent first mounting bracket 24 from moving along elongated support tube 20.

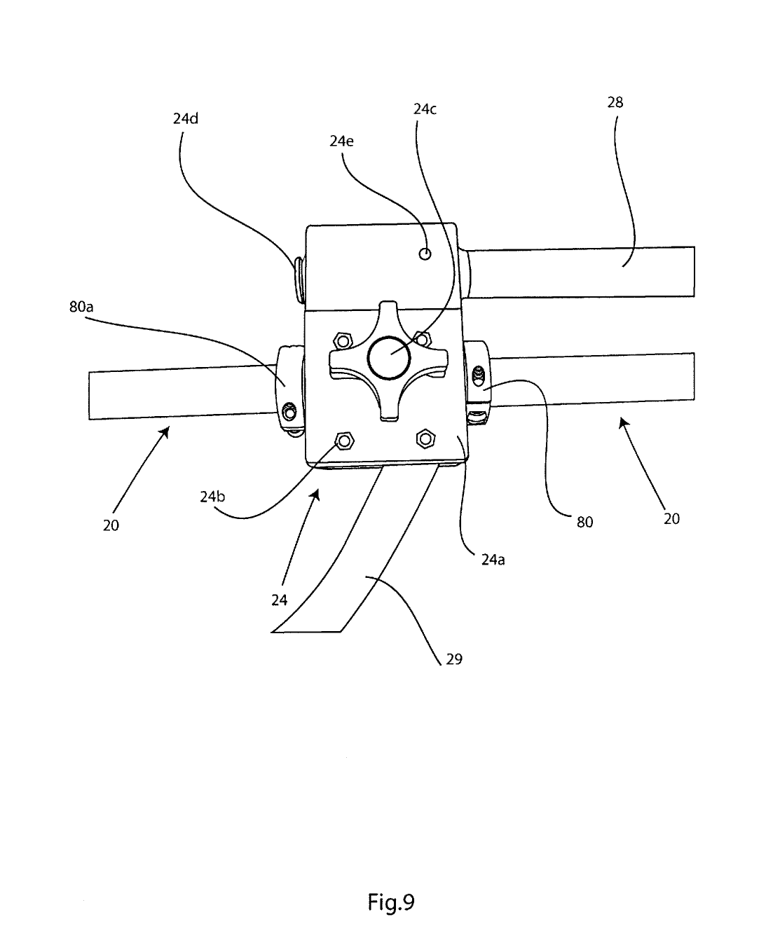

FIG. 9 is similar to FIG. 8, although slightly rotated.

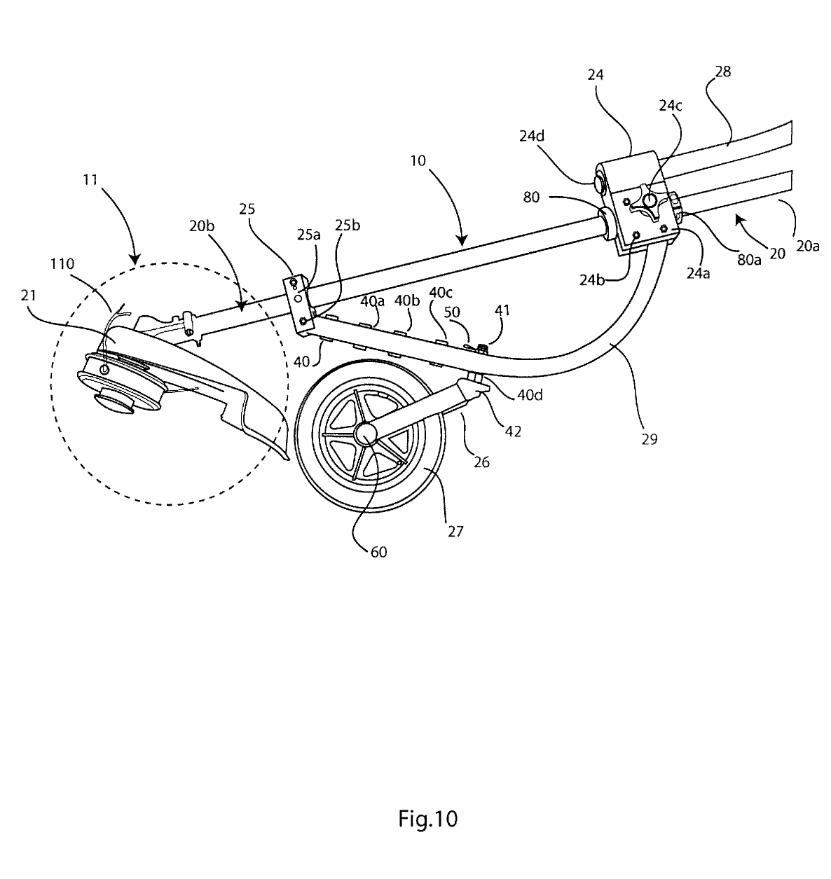

FIG. 10 illustrates an embodiment of a clearing system 10 with clearing head 11 and plastic strings 110 attached to a rotating wheel of the clearing head. The clearing system 10 is being moved backward toward the operator, causing wheel 27 to trail in the illustrated position.

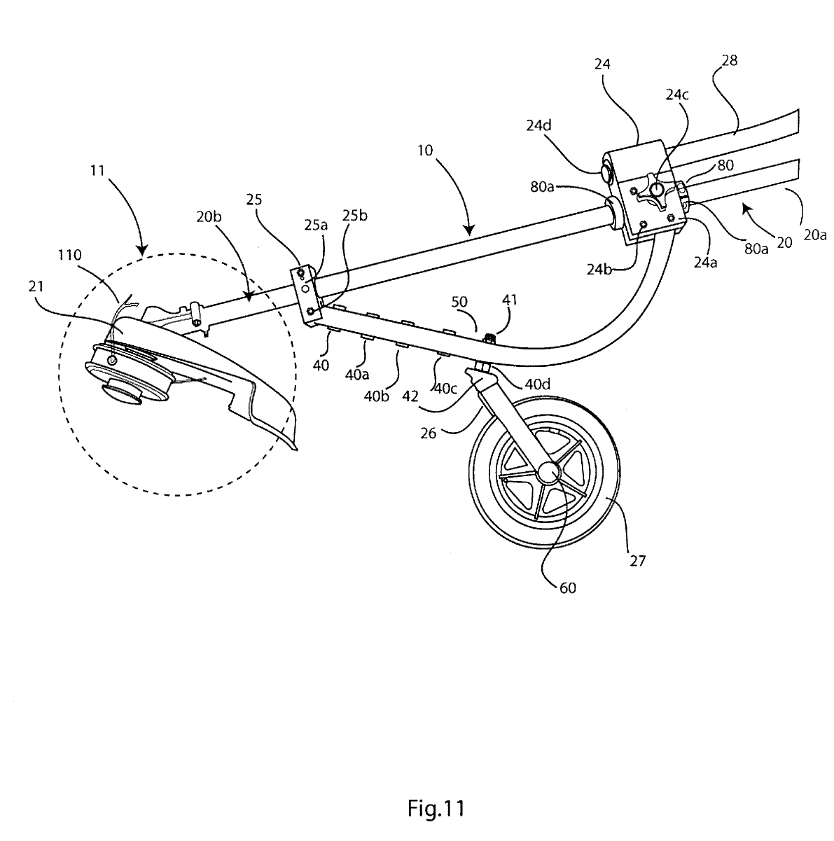

FIG. 11 is a similar view to FIG. 10, illustrating the clearing system 10 being moved forward and wheel 27 trailing the illustrated direction.

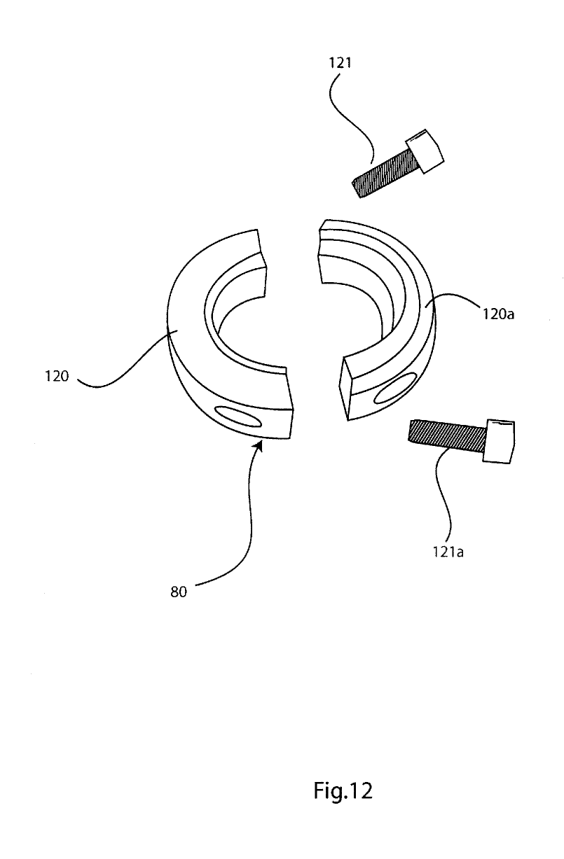

FIG. 12 illustrates detail of the clamp 80 which consists of semicircular halfs 120 and 120a joined by bolts 121 and 121a.

FIG. 14 illustrates two views of clearing head 11, the top in vertical position for edging and the bottom in horizontal position for trimming.

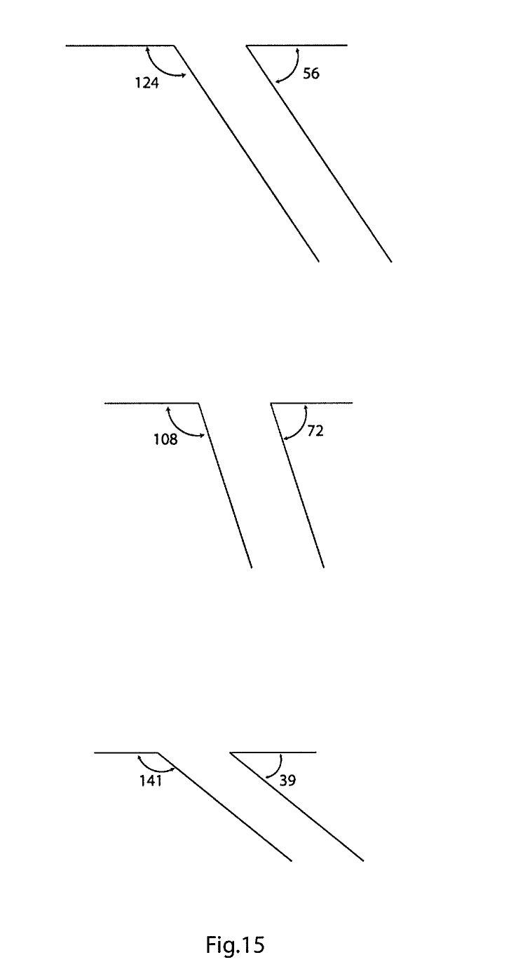

FIG. 15 illustrates three different embodiments of angles at which strut 43 may be arranged. The illustrated offset angles formed by the axis of the castor pin and the axis either of the wheel struts from the wheel axis to a point where the strut meets the transverse plate is about 1 to 89 degrees, corresponding to the inside angles 56, 72, or 39 in this drawing.

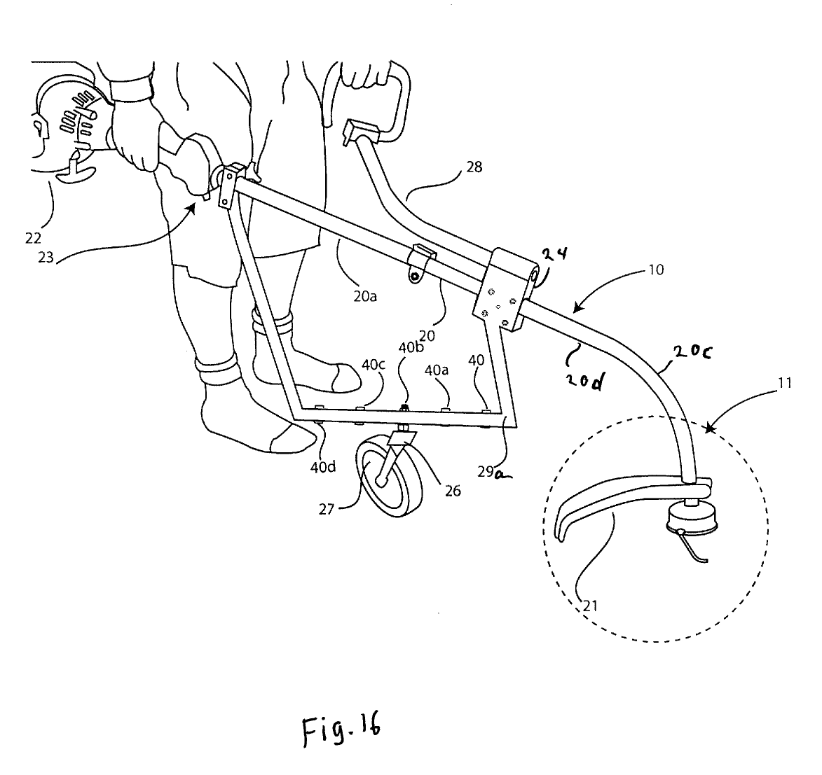

FIG. 16 is a right side view of a second embodiment of the invention wherein curved wheel support member 29 is replaced by an angular support member 29a designed for an elongated curved support tube 20d having a straight proximal portion 20a and a curved distal end 20c closer to the string clearing head 21. In this embodiment, the guide handle 28 and first mounting bracket 24 are mounted at the distal end of the elongated angular support tube 29a.

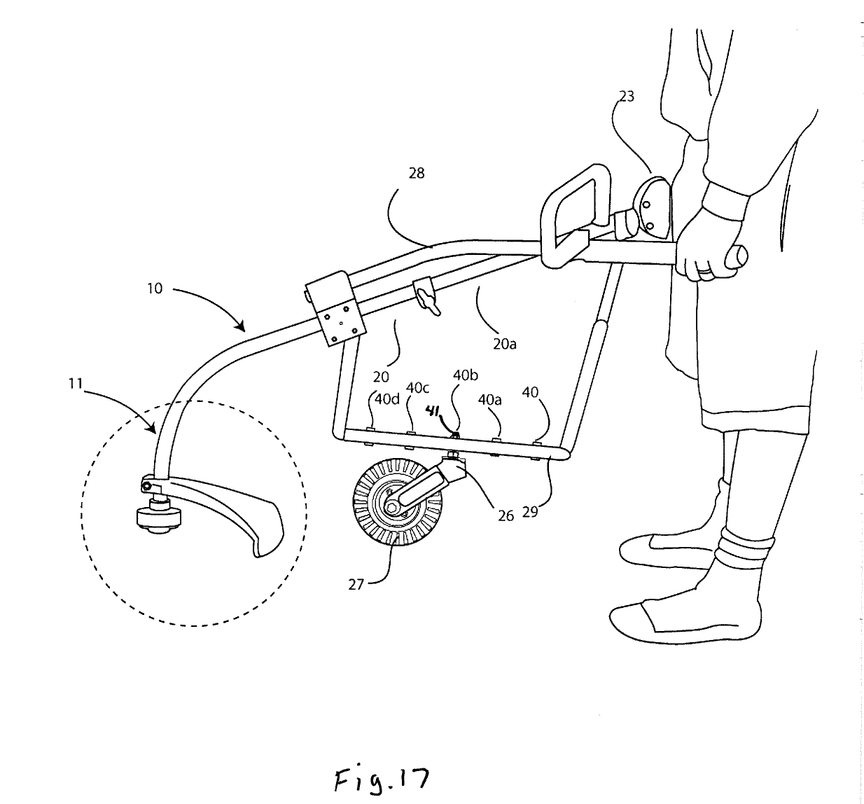

FIG. 17 is a left side view of the second embodiment shown in FIG. 16, with the clearing device 10 being moved in a rearward direction, causing the wheel 27 to trail and always be behind the castor pin 41 with respect to the direction of movement of the clearing device 10.

In operation, the carriage system of the invention has many advantages over prior carriages for supporting clearing devices, among which are simplicity of operation, commercial practicability, ease of adjustment of the location of the wheel so that it can be placed in a selected location forward or rearward for various uses. The wheel in this system is smaller than in many prior systems and does not get in the way of the clearing device. Furthermore, the clearing device when supported on the carriage system can be moved in any direction and the wheel will follow or trail the direction of movement, somewhat similar to the front wheels of supermarket carts.

While the invention has been described and illustrated sufficient detail, various modifications and alternative embodiments should become apparent without departing from the spirit and scope of the invention.

What is claimed is:

1. A carriage for supporting a clearing device of the type having an elongated support tube having a proximal end and a distal end, a clearing head mounted at the distal end of the elongated support tube, a motor mounted at the proximal end of the elongated support tube, and drive means connecting the clearing head to the motor;
a. the carriage comprising a first mounting bracket; a second mounting bracket; a curved, L-shaped, or angular wheel support member; a castor bracket; a single support wheel; and a guide handle;
b. the guide handle mounted in the first mounting bracket and of sufficient length and configuration that it can be grasped by an operator for guiding the carriage during use;
c. the first mounting bracket and the second mounting bracket each adapted to be mounted on the elongated support tube of the clearing device at different positions;
d. the castor bracket including a castor pin extending vertically from a transverse plate, a pair of castor wheel struts extending from the transverse plate, a wheel axle extending between the pair of castor wheel struts, and the single support wheel rotatably mounted on the wheel axle;
e. the wheel support member having at least two holes for receiving the castor pin, the holes being perpendicular or nearly perpendicular to the ground when the clearing head is in use;
f. the castor pin being removable and relocatable at any of the holes so the wheel may be located at a selected position along the wheel support member.

2. The carriage of claim 1 wherein the wheel axle is offset from the castor pin so that the wheel rotates in a horizontal plane around the axis of the vertical castor pin as the clearing device is guided in different directions and so that the single support wheel will tend to trail the direction of movement of the clearing device.

3. The carriage of claim 1 wherein an offset angle between the transverse plate and the wheel struts is about 1 to 89 degrees.

4. The carriage of claim 1 wherein an offset angle between the transverse plate and the wheel struts is about 35 to 75 degrees.

5. The carriage of 1 wherein an offset angle between the transverse plate and wheel struts is about 50 to 60 degrees.

6. The carriage of claim 1 wherein the first bracket includes rotation restriction means to release or reengage the guide handle to selectively permit rotation of the guide means to adapt the carriage for either right handed users, left handed users, or storage.

7. The carriage of claim 6 wherein the wherein the means is a spring button.

8. The carriage of claim 1 wherein the first and second mounting brackets each comprise a pair of mounting members which can be clamped around the elongated support tube of the clearing device and maintained in place with screws or bolts.

9. The carriage of claim 1 wherein the clearing system is selected from the group consisting of tiller, trimmer, blower, edger, bush cutter.

10. The carriage of claim 1 wherein the clearing system is a string trimmer or string edger.

11. The carriage of claim 1 wherein the first and second mounting brackets are adapted to be loosened to allow free rotation of the elongated support tube.

12. The carriage of claim 1 wherein the plurality of holes in the wheel support member for receiving the castor pin are marked to indicate corresponding hand height from the ground when the castor pin is in each selectable hole.

13. The carriage of claim 1 wherein the guide handle, b., is adjustable in length.

14. A clearing system comprising
a. a clearing apparatus having an elongated support tube having a proximal end and a distal end, a cutter head mounted at the distal end of the elongated support tube for trimming vegetation, a motor mounted at the proximal end of the elongated support tube, and drive means connecting the cutter head to the motor;
b. a carriage supporting the clearing apparatus comprising a first mounting bracket; a second mounting bracket; a curved, L-shaped, or angular wheel support member; a castor bracket; a single support wheel; and a guide handle;
c. the guide handle mounted in the first or second mounting bracket and of sufficient length and configuration that it can be grasped by an operator for guiding the carriage during use;
d. the first mounting bracket and the second mounting bracket each mounted on the elongated support tube of the clearing apparatus;
e. the castor bracket including a castor pin extending vertically from a transverse plate, a pair of castor wheel struts extending from the transverse plate, a wheel axle extending between the pair of castor wheel struts, and a wheel rotatably mounted on the wheel axle; the wheel support member having a plurality of holes for receiving the castor pin, the castor pin being removable and relocatable at any of the plurality of holes so the wheel may be located at a selected position along the wheel support member.

15. The clearing system of claim 14 wherein the wheel axle is offset from the castor pin so that the wheel rotates in a horizontal plane around the axis of the vertical castor pin as the clearing device is guided in different directions and so that the single support wheel will tend to trail the direction of movement of the clearing device.

16. The clearing system of claim 14 wherein the first and second mounting brackets each comprise a pair of mounting members which are clamped around the elongated support tube of the clearing device and maintained in place with screws or bolts.

17. The clearing system of claim 14 wherein an offset angle formed between the transverse plate and the wheel struts is about 1 to 89 degrees.

18. The clearing system of 14 wherein an offset angle between the transverse plate and the wheel struts is about 35 to 75 degrees.

19. The clearing system of 14 wherein an offset angle between the transverse plate and wheel struts is about 50 to 60 degrees.

20. The clearing system of claim 14 wherein the first bracket includes rotation restriction means to release or reengage the guide handle to selectively permit rotation of the guide means to adapt the carriage for either right handed users, left handed users, or storage.

21. The clearing system of claim 20 wherein the wherein the means is a spring button

22. The clearing system of claim 14 wherein the clearing system is selected from the group consisting of tiller, trimmer, blower, edger, bush cutter.

23. The clearing system of claim 14 wherein the clearing system is a string trimmer or string edger.

24. The clearing system of claim 14 wherein the first and second mounting brackets are adapted to be loosened to allow free rotation of the elongated support tube so that the clearing device can be selectively operated with a cutter angle parallel to the ground or at an edger angle, and wherein at least one collar is provided on the elongated support tube adjacent and proximal and/or distal to the first and/or second mounting bracket, arranged to prevent the elongated support tube from sliding forward or backwards during the free rotation.

25. A method of supporting a clearing device of the type having an elongated support tube having a proximal end and a distal end, a cutter head mounted at the distal end of the elongated support tube for trimming vegetation, a motor mounted at the proximal end of the elongated support tube, and drive means connecting the cutter head to the motor comprising the steps of securing the clearing device to the support carriage of claim 1.
